(19) United States
(12) Patent Application Publication
(10) Pub. No.: US 2025/0389895 A1
(43) Pub. Date: Dec. 25, 2025

(54) FUSION SPLICER AND METHOD FOR CONNECTING OPTICAL FIBERS

(71) Applicant: FURUKAWA ELECTRIC CO., LTD., Tokyo (JP)

(72) Inventor: Akio Tanabe, Tokyo (JP)

(21) Appl. No.: 19/307,698

(22) Filed: Aug. 22, 2025

Related U.S. Application Data
(63) Continuation of application No. PCT/JP2024/015703, filed on Apr. 22, 2024.

(30) Foreign Application Priority Data
Apr. 26, 2023 (JP) 2023-072341

(51) Int. Cl. G02B 6/255; G02B 6/02

(52) U.S. Cl. CPC G02B 6/2553; G02B 6/02328; G02B 6/2551

(57) ABSTRACT

Three electrodes are circumferentially arranged at substantially equal intervals (about 120°) on the outer periphery of a hollow core fiber in a fusion section where the tip sections of optical fibers are butted and fused. When viewed from the axial direction of the hollow core fiber, the center of a triangle connecting the tips of the electrodes and the cross-sectional center of the hollow core fiber substantially coincide with each other. A control unit applies a voltage between the electrodes of a prescribed combination for a preset period of time, and is capable of sequentially changing the combination of the electrodes for each period of time.

### TECHNICAL FIELD

The present invention relates to a fusion splicer and the like that can fusion splice optical fibers having unique cross-sectional forms, such as hollow core fibers and photonic bandgap fibers.

### BACKGROUND

Fusion splicers are used to connect optical fibers together. In a fusion splicer, optical fibers held by a pair of holders are butted to each other and disposed between electrodes, and tips of the optical fibers are fused together by an arc so that the optical fibers are connected to each other.

In a common fusion splicer used for fusing optical fibers together, a pair of electrodes are disposed and the optical fibers are disposed being butted together between the pair of electrodes so that the optical fibers can be fused together by generating an arc between the electrodes. In contrast, in cases of optical fibers such as thick-diameter optical fibers or multicore optical fibers, the optical fibers may not be uniformly heated by the arc.

To heat optical fibers uniformly even in such cases, National Application of International Patent Application No. 2010-518449 (JP-T-2010-518449) and International Patent Publication No. WO2012/099883, for example, have proposed a method in which three electrodes are disposed evenly around an outer circumference of the optical fibers and an arc is generated between each pair of the electrodes, thereby forming a substantially uniform heating zone.

In JP-T-2010-518449 and WO2012/099883, an arc is generated between each pair of electrodes by applying three-phased high-frequency voltage across three electrodes, and optical fibers are disposed in a space surrounded by the arcs. The arc generated between each pair of electrodes changes according to a phase difference of the voltage applied to each electrode. That is, combination of the electrodes at which the arc is generated changes.

However, according to JP-T-2010-518449 and WO2012/099883, the voltage applied to the electrodes is a high-frequency voltage of 22 kHz, for example, and thus a period of time in which the arc is generated between each pair of electrodes is approximately 15 μs and the arc between the electrodes shifts in an extremely short time. Thus, it appears that the arcs are generated between all the electrodes at all times, and JP-T-2010-518449 and WO2012/099883 have disclosed that a substantially uniform heating zone can be formed in a space surrounded by the three electrodes.

As above, according to JP-T-2010-518449 and WO2012/099883, even if the optical fibers disposed inside have thick diameters, by disposing the optical fibers within such the uniform heating zone, the entire optical fibers can be heated substantially uniformly for fusion.

Meanwhile, unique optical fibers such as hollow core fibers and photonic bandgap fibers have been developed in the recent years. For example, a hollow core fiber is a fiber in which light is trapped in air tubes, and, to form such the air tubes, the hollow core fiber has a fine internal structure. Thus, the hollow fiber has a thick glass wall on an outer periphery thereof to ensure strength, and thin glass partition walls inside to form fine air layers.

If such the optical fibers are fused together by using an ordinary method, the internal fine structure would melt and disappear, which may cause light leakage. However, if a heating temperature is reduced excessively, the outer periphery would not melt sufficiently, which decreases the fusion strength and may cause a fracture at a connected part.

Also, when fusing by using three electrodes as in the methods of JP-T-2010-518449 and WO2012/099883 even though outer periphery portions of the optical fibers are positioned on straight lines between the electrodes, the substantially uniform heating zone is formed as mentioned above, and thus it is impossible to prevent excessive melting at the center. Or rather, since the uniform heating zone is larger compared to a case in which fusion is performed using only the pair of electrodes, melting of the center parts of the optical fibers surrounded by the three arcs may be promoted and the fine air layers may be damaged.

### SUMMARY OF THE DISCLOSURE

The present invention was made in view of such problems. It is an object of the present invention to provide a fusion splicer and the like, in which even unique optical fibers, such as hollow core fibers and photonic bandgap fibers, can be efficiently fused together.

To achieve the above object, a first aspect of the present invention is a fusion splicer for connecting optical fibers together. The fusion splicer includes three or more electrodes that are disposed at a fusion part at which tips of the optical fibers are butted to be fused together, and a control unit for controlling voltage applied to each of the electrodes. The control unit is capable of discharging between the electrodes of a prescribed combination for a preset period of time and, at the same time, is capable of sequentially changing the combination of the electrodes to be discharged for each period of time.

It is preferable that the control unit is capable of setting a discharge stop period during which discharging between all the electrodes is stopped for a prescribed period of time after discharging between the electrodes of the prescribed combination before discharging between the electrodes of the next combination.

The four or more electrodes may be disposed at predetermined intervals and the control unit may sequentially apply voltage to the combinations of all the electrodes that are adjacent to each other in a circumferential direction.

The control unit may be capable of applying voltage to a plurality of combinations of the electrodes at the same time, thereby discharging between two or more pairs of the electrodes at the same time.

According to the first aspect of the present invention, when performing fusion using three or more electrodes, an arc is generated for a set period of time for a predetermined electrode combination, and the electrode combination is sequentially changed so that a straight line connecting the electrodes can be preferentially heated. Thus, only outer periphery portions of optical fibers are selectively heated, thereby suppressing heating of center parts of the optical fibers.

Also, by providing the discharge stop period of a predetermined time between applying voltage across the electrodes of the prescribed combination to generate an arc and applying voltage across the electrodes of the next combination to generate an arc, it is possible to prevent the center part of the optical fibers from being excessively heated.

Also, by using four or more electrodes and sequentially applying voltage to combinations of all the circumferentially adjacent electrodes, it is possible to generate arcs at finer angles on outer periphery portions of the optical fibers compared to the case in which three electrodes are used.

Also, if voltage is applied to a plurality of combinations of the electrodes at the same time and discharging is performed between two or more pairs of the electrodes, a period of time in which arcs are generated to the entire periphery of the optical fibers can be shortened.

A second aspect of the present invention is a method for connecting optical fibers using a fusion splicer. The fusion splicer includes three or more electrodes that are disposed at a fusion part at which tips of the optical fibers are butted to be fused together, and a control unit for controlling voltage applied to each of the electrodes. The control unit is capable of discharging between the electrodes of a prescribed combination for a preset period of time and, at the same time, is capable of sequentially changing the combination of the electrodes for each period of time.

The optical fibers may be hollow core fibers or optical fibers including a core and a cladding on an outer periphery of the core with at least one hollow hole in the cladding. The outer periphery portions of the optical fibers are discharged so that the outer periphery portions of the optical fibers are fused together and fusion may not occur inside the optical fibers.

The optical fibers may include a plurality of cores and a cladding on an outer periphery of the cores, and the outer periphery portions of the optical fibers are discharged and the optical fibers are fused together such that temperature distribution on the outer periphery portions of the optical fibers during fusion is higher than a temperature inside the optical fibers.

According to the second aspect of the present invention, when performing fusion using three or more electrodes, an arc is generated only for a set period of time for the predetermined electrode combination and, by changing the electrode combination sequentially, the straight lines connecting the electrodes can be preferentially heated. Thus, only the outer periphery portions of the optical fibers are selectively heated, thereby suppressing heating of center parts of the optical fibers.

Also, for hollow core fibers or optical fibers such as photonic bandgap fibers having hollow holes in the cladding, by fusing the outer periphery portions thereof with certainty, the connection strength can be obtained with certainty and thin partition walls on inner periphery portions of the optical fibers hardly melt or only melt to a small extent. Thus, the optical fibers can be fused together while maintaining air layers.

Also, for multicore fibers having a plurality of cores, for example, the cores in proximity of outer periphery portions, which are more susceptible to core misalignment, can be sufficiently heated to promote diffusion of core dopant. This can enlarge mode field diameters of the cores on an outer periphery side and suppress an influence of the misalignment of the cores.

The present invention can provide a fusion splicer and the like, in which even unique optical fibers, such as hollow core fibers and photonic bandgap fibers, can be efficiently fused together.

### BRIEF DESCRIPTION OF DRAWINGS

FIG. 1 is a perspective view showing a fusion splicer 1.

FIG. 2A is a cross-sectional schematic view of a hollow core fiber.

FIG. 2B is a cross-sectional schematic view of a photonic bandgap fiber.

FIG. 3A is a view showing a step during fusion splicing.

FIG. 3B is a view showing a step during fusion splicing.

FIG. 3C is a view showing a step during fusion splicing.

FIG. 4A is a view showing a circuit during the fusion splicing in FIG. 3A.

FIG. 4B is a view showing the circuit during the fusion splicing in FIG. 3B.

FIG. 4C is a view showing the circuit during the fusion splicing in FIG. 3C.

FIG. 5A is a schematic view showing a discharge timing chart for FIG. 3A to FIG. 3C.

FIG. 5B is a schematic view showing another discharge timing chart.

FIG. 5C is a schematic view showing another discharge timing chart.

FIG. 6A is a schematic view showing a discharge timing chart when using four electrodes.

FIG. 6B is a schematic view showing the discharge timing chart when using the four electrodes.

FIG. 6C is a schematic view showing the discharge timing chart when using the four electrodes.

FIG. 7 is a cross-sectional view of a multicore fiber 31.

### DETAILED DESCRIPTION

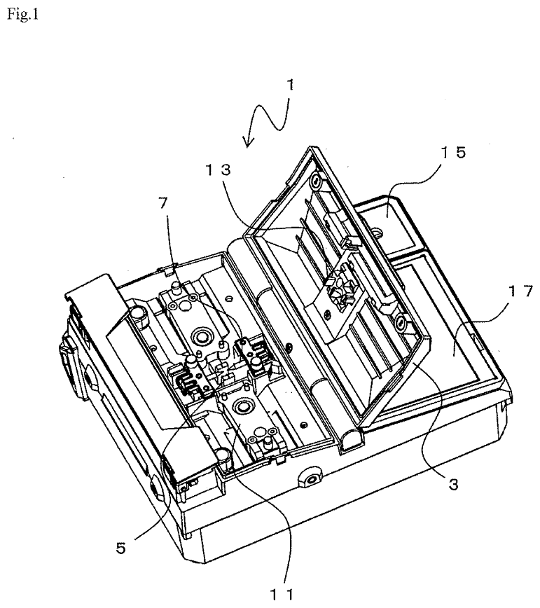

Hereinafter, embodiments of the present invention will be described with reference to the accompanying drawings. FIG. 1 is a perspective view showing a fusion splicer 1. The fusion splicer 1 connects a pair of optical fibers by fusion. Illustrations of structures that are unnecessary for explanation will be omitted in the drawings hereinafter.

As shown in FIG. 1, the fusion splicer 1 has a lid portion 3 that can be opened or closed with respect to a main body. Also, the main body includes a holder mounting part 11 on which a holder for holding an optical fiber is mounted, an optical fiber holding part 5 that holds and positions a tip of the optical fiber, an operation unit 15 that performs various settings for the fusion splicer 1 as well as alignment operation and fusion operation etc., which will be described below, a display unit 17 that displays various information and images, and so on. The operation unit 15 and the display unit 17 may be integrated by making the display unit 17 a touch panel.

The optical fiber is held in a V groove in the optical fiber holding part 5. Also, three electrodes 7 are disposed in a direction substantially perpendicular to an opposing direction of a pair of the optical fibers. An arrangement of the electrodes 7 will be described in detail below.

The lid portion 3 can be opened or closed with respect to the main body. A clamp 13 is provided on a back surface of the lid portion 3, and, when the lid portion 3 is closed, a tip of the clamp 13 is positioned at a part that corresponds to the positions of the optical fibers on the optical fiber holding part 5. That is, the clamp 13 that is provided on the back surface of the lid portion 3 can hold the pair of optical fibers facing each other in the optical fiber holding part 5.

The optical fibers are held by a pair of holders, which are not shown, and the holders are mounted on the holder mounting part 11. The lid portion 3 is closed in such the state, and an arc is generated between the electrodes 7 with tips of the optical fibers being butted to each other so that the tips of the optical fibers can be melted and joined together. Such the fusion splicer 1 is effective especially for connecting unique optical fibers such as hollow core fibers or photonic bandgap fibers.

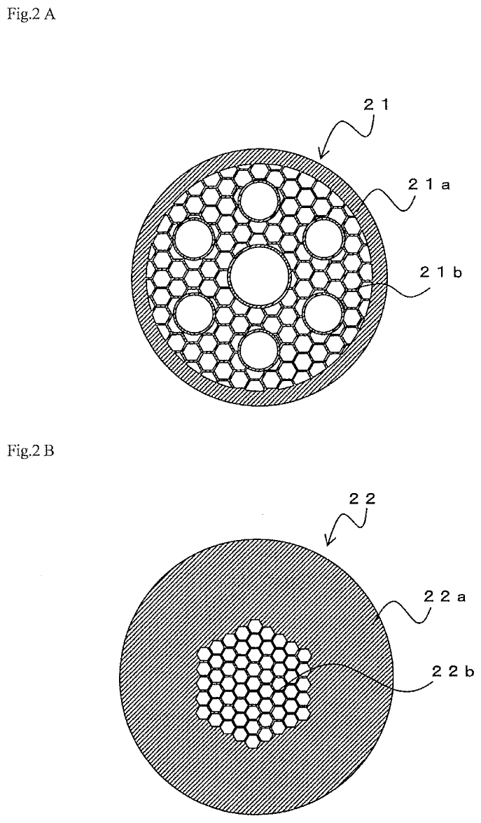

FIG. 2A is a cross-sectional schematic view of a hollow core fiber 21. The hollow core fiber 21 has a thick glass outer periphery portion 21a, and air layers partitioned by thin wall portions 21b are formed inside the outer periphery portion 21a. That is, the hollow core fiber 21 is configured with the thick outer periphery portion 21a and the internal thin wall portions 21b.

FIG. 2B is a cross-sectional schematic view of a photonic bandgap fiber 22. Although having a different cross-sectional shape from the hollow core fiber 21, the photonic bandgap fiber 22 also has thin wall portions 22b that partition the space inside an outer periphery portion 22a (a glass solid portion). Instead of the photonic bandgap fiber 22 shown in the drawing, any optical fibers having a core and a cladding on an outer periphery of the core with at least one hollow hole in the cladding can be applied to the present embodiment.

If the hollow core fibers 21 or the photonic bandgap fibers 22 are to be fused together in the same manner as in ordinary optical fibers, the outer periphery portions 21a and 22a are to be completely melted for fusion connection. In such the case, when the outer periphery portions 21a and 22a are melted, the thin wall portions 21b and 22b may disappear, which may cause light leakage. On the other hand, if heating temperature is reduced to prevent the internal thin wall portions 21b and 22b from melting, the outer periphery portions 21a and 22a would not melt sufficiently, which decreases the fusion strength and may cause a fracture at a connected part.

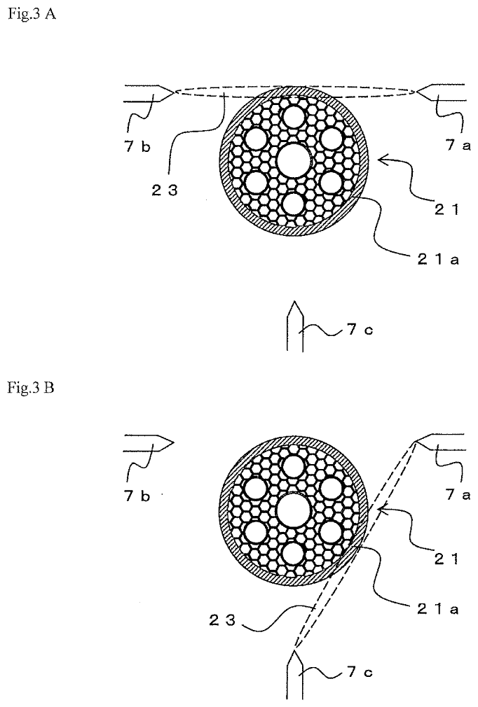

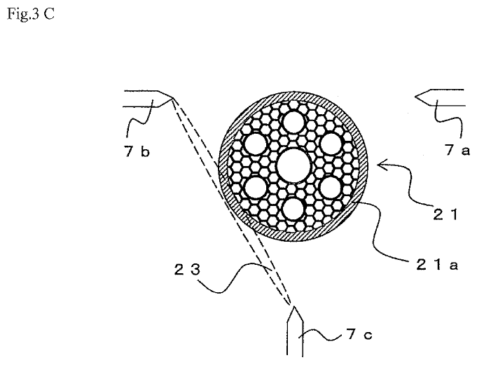

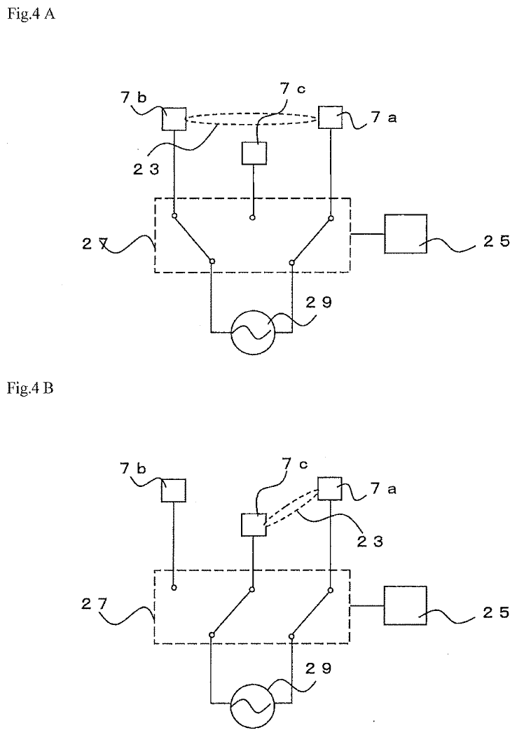

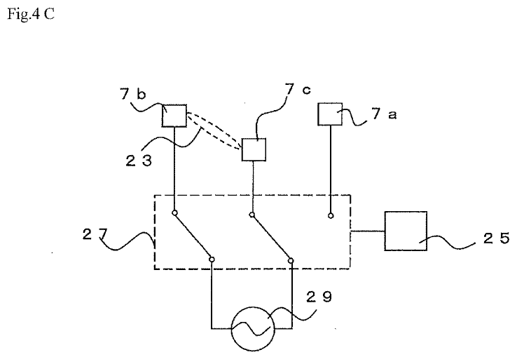

Next, a method for connecting the optical fibers together using the fusion splicer 1 according to the present embodiment will be described in detail. FIG. 3A to FIG. 3C are views showing positional relationships between the electrodes and the hollow core fiber 21 in a state in which an arc 23 is generated between each pair of the electrodes. FIG. 4A to FIG. 4C are schematic views showing circuits for FIG. 3A to FIG. 3C, respectively.

As shown in FIG. 3A to FIG. 3C, at a fusion part where tips of the optical fibers are butted to be fused together, the three electrodes 7a, 7b, and 7c (all the electrodes 7a, 7b, and 7c may be collectively referred to as electrodes 7) are disposed on the outer periphery of the hollow core fiber 21 at substantially equal intervals (approximately 120°) in a circumferential direction. Although the hollow core fibers 21 are used for explanation as optical fibers to be fused together in the description hereafter, the same also applies to the photonic bandgap fibers 22 and the like.

When viewed from an axial direction of the hollow core fiber 21, a center of a triangle connecting the tips of the electrodes 7a, 7b, and 7c and a cross-sectional center of the hollow core fiber 21 substantially coincide with each other. Also, the electrodes 7a, 7b, and 7c are disposed such that lines connecting the respective electrodes 7a, 7b, and 7c (lines connecting the respective tips of the electrodes 7a, 7b, and 7c) are positioned on the outer periphery portion 21a of the hollow core fiber 21. That is, the lines connecting the respective electrodes 7a, 7b, and 7c and the cross-sectional center of the hollow core fiber 21 are positioned being misaligned.

As shown in FIG. 4A to FIG. 4C, each of the electrodes 7a, 7b, and 7c is connected to a power source 29, which is a high-frequency high-voltage power source, via a switch 27. A control unit 25 controls the switch 27. That is, the control unit 25 can control voltage applied to the respective electrodes by switching the switch 27.

For example, FIG. 3A is a view showing a state in which the arc 23 is formed between the electrodes 7a and 7b. In such the case, the control unit 25 switches the switch 27 such that the power source 29 can be connected to the electrodes 7a and 7b. Thus, voltage is applied across the electrodes 7a and 7b, thereby generating the arc 23.

Similarly, FIG. 3B is a view showing a state in which the arc 23 is formed between the electrodes 7a and 7c, and FIG. 4B is a view showing a circuit diagram at this time. In such the case, the control unit 25 switches the switch 27 to connect the power source 29 to the electrodes 7a and 7c and voltage is applied across the electrodes 7a and 7c, thereby generating the arc 23.

Similarly, FIG. 3C is a view showing a state in which the arc 23 is formed between the electrodes 7b and 7c, and FIG. 4C is a view showing a circuit diagram at this time. In such the case, the control unit 25 switches the switch 27 to connect the power source 29 to the electrodes 7b and 7c and voltage is applied across the electrodes 7b and 7c, thereby generating the arc 23.

In FIG. 3A to FIG. 3C, an area where the arc 23 and the hollow core fiber 21 overlap becomes hot, and the temperature drops rapidly when moving away from this area. Thus, in FIG. 3A to FIG. 3C, respectively, a part of the circumferential direction of the outer periphery portion 21a of the hollow core fiber 21 is locally heated, and heating of the other parts are suppressed.

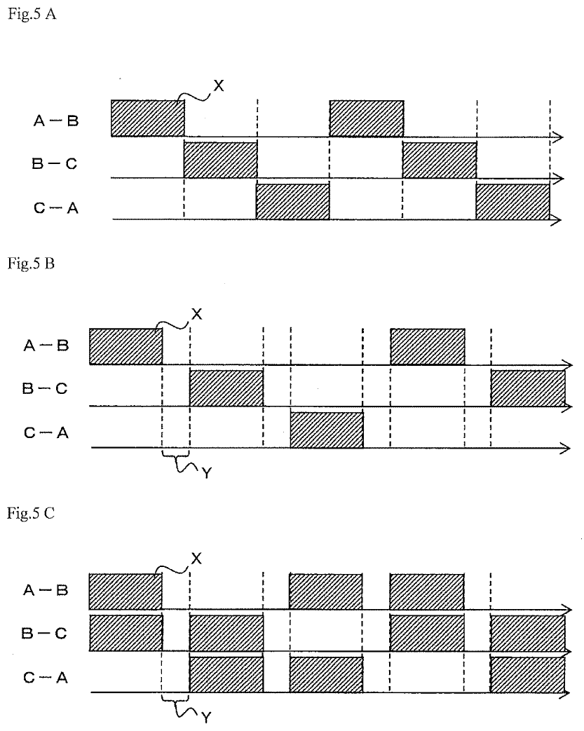

FIG. 5A is a schematic view showing a discharge timing chart. A-B, B-C, and C-A in the drawing show an electrode combination of the electrodes 7a, 7b, and 7c, respectively, and time is on the horizontal axis. Also, a hatched portion (X portion) in the drawing shows a state in which voltage is applied across the electrodes for discharge (a state in which the arc 23 is generated). The control unit 25 applies voltage across the electrodes of the predetermined combination for the preset period of time and is also capable of sequentially changing the electrode combination for each period of time.

The example shown in FIG. 5A appears to be similar to Patent Documents 1 and 2. However, in Patent Documents 1 and 2, as mentioned above, the position of arc between the electrodes changes due to phase difference formed by the high-frequency circuits and thus each discharging period (a width of X part in the drawing) is several μm to ten plus several μm. In this way, in Patent Documents 1 and 2, the substantially uniform heating zone is formed.

In the present embodiment on the other hand, discharge is maintained between the electrodes for the period of time set by the control unit 25. For example, the control unit 25 maintains discharging between the same electrodes for a period of approximately 0.1 to 1 second (several thousands to several tens of thousands of cycles of the high-frequency voltage). After the predetermined time has elapsed, the switch 27 is switched to change the electrodes to be discharged, and this is repeated to perform fusion splicing. That is, in the present embodiment, rather, only a part of the circumferential direction of the outer periphery portion 21a of the hollow core fiber 21 is heated locally, thereby suppressing heating of the rest of the outer periphery portion 21a and the center part.

In this way, by intentionally performing non-uniform heating and not always heating the center of the hollow core fiber 21, melting of the thin-wall portions 21b inside can be suppressed, and only the outer periphery portion 21a can be melted and fused with certainty.

Although the control unit 25 controls the voltage applied to each electrode by switching the switch 27 in the circuit in the above embodiment, the present invention is not limited thereto. For example, the control unit 25 may generate a phase difference between sinusoidal voltage applied to each electrode, and control the discharge to occur only between predetermined electrodes. For example, voltage control of the electrodes to be discharged may be performed by applying a sinusoidal wave voltage with a phase difference of 180° between the electrodes to be discharged and applying a sinusoidal wave voltage with a phase difference of 90° to the other electrodes, so that the voltage between only the electrodes to be discharged exceeds the breakdown voltage of air due to the phase difference. Thus, in the present invention, the “voltage control” also includes the control of the phase of the voltage for each electrode (the phase difference between the electrodes). Thus, in the present invention, the control method is not particularly limited as long as the control unit 25 is capable of controlling the voltage (including the phase difference) for a preset time to enable discharging between a predetermined combination of electrodes and the combination of electrodes for discharge can be changed sequentially for each period of time.

As above, according to the present embodiment, when the optical fibers to be connected are hollow core fibers 21 or photonic bandgap fibers 22, by locally heating the outer periphery portions 21a or 22a of the hollow core fibers 21 or the photonic bandgap fibers 22, it is possible to suppress melting of the thin wall portions 21b or 22b at the center. In particular, since the entire circumference is not heated uniformly, the outer periphery portions 21a or 22a on a side that is not heated are also cooled down. This can suppress heat from entering into the center with more certainty.

As above, a part of the outer periphery portions of the hollow core fibers 21 or the photonic bandgap fibers 22 are discharged so as to fuse together the outer periphery portions 21a or 22a, and, at the same time, no fusion occurs inside the hollow core fibers 21 or the photonic bandgap fibers 22 such that fusion connection can be performed without melting the thin wall portions 21b or 22b.

The voltage control to each pair of electrodes by the control unit 25 is not limited to the above-mentioned examples. For example, as shown in FIG. 5B, after applying voltage between a predetermined combination of electrodes for discharge, the control unit 25 may stop applying voltage to all the electrodes for a predetermined period of time until applying voltage across the electrodes of the next combination for discharge, or may set a phase difference so that discharge does not occur between all the electrodes, and set a discharge stop period (Y in the drawing) in which discharging between all the electrodes is stopped. That is, during the discharge stop period, no voltage is applied to any of the electrodes, or, due to the phase difference between the voltages of all the electrodes, the voltage between the electrodes is kept below the breakdown voltage, resulting in a state where no discharge occurs. By forming the discharge stop period in this way, it is possible to suppress a rise in temperature especially at the center of the optical fibers.

Also, although the discharge occurs only at one place between one pair of the electrodes in the above-mentioned embodiments, the present invention is not limited thereto. For example, as shown in FIG. 5C, the control unit 25 may apply voltage simultaneously to a plurality of combinations of the electrodes, thereby discharging two or more pairs of electrodes at the same time. For example, discharge may occur at two places between the three electrodes 7a, 7b, and 7c. That is, discharge between at least a part of the adjacent electrodes may be stopped. Even in such the case, the combinations of the electrodes to be discharged may be changed over time, and, at the same time, the discharge stop period may be provided between the discharges between the electrodes.

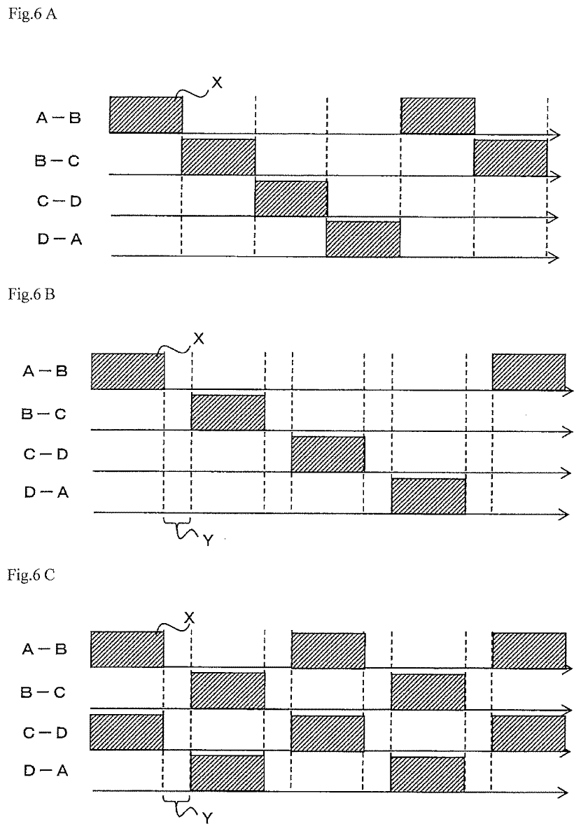

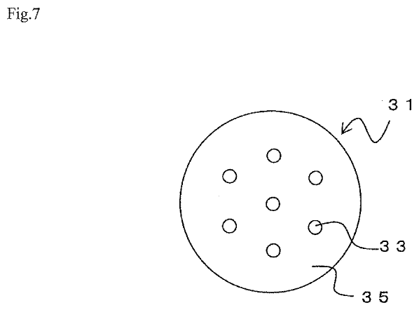

Also, although examples in which the three electrodes are used have been described in the above-mentioned embodiments, the present invention is not limited thereto. For example, four or more electrodes may be used. FIG. 6A is a view showing an example in which the four electrodes are used. A-B to D-A show the combination of the adjacent electrodes in which four electrodes A, B, C, and D are disposed in the circumferential direction, respectively. When four electrodes are used, the electrodes are disposed at 90° intervals around the optical fiber. Even when the four or more electrodes are disposed at predetermined intervals as above, the control unit 25 may apply voltage sequentially to all the combinations of the electrodes that are adjacent to each other in the circumferential direction, thereby providing the similar effects.

Also, even in such the case, as shown in FIG. 6B, the discharge stop period Y during which no voltage is applied to the electrodes may be provided between X periods during which voltage is applied between the electrodes. Also in such the case, as shown in FIG. 6C, voltage may be applied to the plurality of pairs of electrodes at once. In the example shown in FIG. 6C, although the electrodes that are discharged simultaneously face each other, the adjacent electrodes may also be discharged simultaneously.

Also, although examples in which hollow core fibers 21 or the photonic bandgap fibers 22 are applied as the optical fibers to be connected have been described in the above-mentioned examples, the present invention is not limited thereto. FIG. 6 is a cross-sectional view of a multicore fiber 31. The multicore fiber 31 includes a plurality of cores 33 and a cladding 35 covering the cores 33. In the illustrated example, the center core 33 is surrounded by the other cores 33 that are disposed at equal intervals.

Unlike the above-mentioned hollow core fibers 21 and the photonic bandgap fibers 22, the cores 33 of the multicore fibers 31 cannot be connected to each other unless the center parts thereof are melted. On the other hand, when aligning the multicore fibers 31, although the center cores 33 are not affected by rotational alignment, the cores 33 on an outer periphery side are affected by misalignment of the rotational alignment and thus are likely to have greater transmission loss than the center cores 33.

By using the fusion splicer 1 for connecting the multicore fibers 31 by fusion to melt the multicore fibers 31 to the center to be fused, such the influence can be reduced. To melt the multicore fibers 31 to the center, for example, there is a method that brings the straight lines connecting the tips of the electrodes closer to the center of the multicore fibers 31 than in a case of the hollow core fibers 21 or the like, by reducing a size of a polygon formed by the tips of the electrodes 7, or a method that shortens the period of time for discharging between the electrodes.

In such the case, discharging is performed mainly in proximity of outer periphery portions of the multicore fibers 31, and thus the multicore fibers 31 are fused together such that a temperature distribution on the outer periphery portions of the multicore fibers 31 during fusion is higher than a temperature inside the multicore fibers 31. This can promote diffusion of core dopant of the cores 33 on the outer periphery side. This results in enlargement of mode field diameters of the cores 33 on the outer periphery portions compared to the center cores 33 and suppress an influence of the misalignment of the cores 33 on the outer periphery side. Any optical fibers formed of the cores 33 and the cladding 35 on the outer periphery of the cores 33 and including a plurality of the cores 33 may be applied to the present embodiment even if the optical fibers are not the multicore fibers 31 shown in the drawing.

Other than controlling the switch 27 and controlling voltage of the power source 29, the control unit 25 may also be capable of adjusting intervals between the electrodes depending on types of the optical fibers to be connected, for example. Also, the control unit may be capable of changing the above-mentioned discharging time or the discharge stop period according to the types of the optical fibers.

Also, the control unit 25 may decide to terminate fusion when the predetermined period of time and number of discharge is completed, or may decide to terminate fusion based on the predetermined information of the optical fibers. For example, the control unit may use an image of a fusion part or detect leakage of incident light, and may terminate fusion when predetermined conditions are met.

Also, during discharge, the arrangement of the optical fibers and the electrodes may be rotated relatively in a fixed direction or swung within a predetermined rotation angle range around the central axis of the optical fibers as the rotation axis.

Although the embodiments of the present invention have been described referring to the attached drawings, the technical scope of the present invention is not limited to the embodiments described above. It is obvious that persons skilled in the art can think out various examples of changes or modifications within the scope of the technical idea disclosed in the claims, and it will be understood that they naturally belong to the technical scope of the present invention.

1. A fusion splicer for connecting optical fibers together, the fusion splicer comprising:
three or more electrodes that are disposed at a fusion part at which tips of the optical fibers are butted to be fused together; and
a control unit for controlling voltage applied to each of the electrodes,
wherein the control unit is capable of discharging between the electrodes of a prescribed combination for a preset period of time and, at the same time, is capable of sequentially changing the combination of the electrodes to be discharged for each period of time.

2. The fusion splicer according to claim 1, wherein the control unit is capable of setting a discharge stop period during which discharging between all the electrodes is stopped for a prescribed period of time after discharging between the electrodes of the prescribed combination before discharging between the electrodes of the next combination.

3. The fusion splicer according to claim 1, wherein the four or more electrodes are disposed at predetermined intervals and the control unit sequentially applies voltage to the combinations of all the electrodes that are adjacent to each other in a circumferential direction.

4. The fusion splicer according to claim 1, wherein the control unit is capable of applying voltage to a plurality of combinations of the electrodes at the same time, thereby discharging between two or more pairs of the electrodes at the same time.

5. A method for connecting optical fibers using a fusion splicer comprising:
three or more electrodes that are disposed at a fusion part at which tips of the optical fibers are butted to be fused together; and
a control unit for controlling voltage applied to each of the electrodes,
wherein the control unit is capable of discharging between the electrodes of a prescribed combination for a preset period of time and, at the same time, is capable of sequentially changing the combination of the electrodes to be discharged for each period of time.

6. The method for connecting the optical fibers according to claim 5, wherein the optical fibers are hollow core fibers or optical fibers including a core and a cladding on an outer periphery of the core with at least one hollow hole in the cladding, and the outer periphery portions of the optical fibers are discharged so that the outer periphery portions of the optical fibers are fused together and no fusion occurs inside the optical fibers.

7. The method for connecting the optical fibers according to claim 5, wherein the optical fibers include a plurality of cores and a cladding on an outer periphery of the cores, and the outer periphery portions of the optical fibers are discharged and the optical fibers are fused together such that temperature distribution on the outer periphery portions of the optical fibers during fusion is higher than a temperature inside the optical fibers.
